(19) United States
(12) Patent Application Publication
(10) Pub. No.: US 2014/0139175 A1
(43) Pub. Date: May 22, 2014

(54) Pocket Jumper

(71) Applicant: Jose A. Gonzalez, Rdseda, CA (US)

(72) Inventor: Jose A. Gonzalez, Rdseda, CA (US)

(21) Appl. No.: 14/084,566

(22) Filed: Nov. 19, 2013

Related U.S. Application Data
(60) Provisional application No. 61/728,222, filed on Nov. 19, 2012.

(51) Int. Cl. B60L 11/18; B60R 16/033; H02J 7/00

(52) U.S. Cl. CPC B60L 11/1816; H02J 7/0042; B60R 16/033
USPC 320/101; 320/105

(57) ABSTRACT

A pocket jumper includes a power assembly and a detachable connector for detachably connecting to a vehicle battery. The power assembly includes a rechargeable battery pack and an on/off switch being switched between an “off” position and an “on” position. When the on/off switch is switched at the “off” position, the detachable connector is connected to the vehicle battery that no electrical connection is formed between the battery pack and the vehicle battery. When the on/off switch is switched at the “on” position, the detachable connector is connected to the vehicle battery to electrically connect the battery pack with the vehicle battery with an intention of jump starting the vehicle. Therefore, the pocket jumper prevents any sparking when the detachable connector is connected increasing the safety when compared to conventional vehicle jump starter.

### CROSS REFERENCE OF RELATED APPLICATION

This is a non-provisional application that claims the benefit of priority under 35 U.S.C. §119 to a provisional application having an application No. 61/728,222 and a filing date of Nov. 19, 2012.

### BACKGROUND OF THE PRESENT INVENTION

1. Field of Invention

The present invention relates to the field of vehicle batteries, and more particularly to a portable power supply with the means for electrically connecting to a vehicle battery to provide DC power.

2. Description of Related Arts

The realization that you made have left your car lights on and now your car can't start due to a dead battery is enough to instill in any person that feeling of hopelessness. The typical solution for the average person would be to walk around and ask for a good Samaritan to jump start their car or call a friend to drive to them to provide that jump start. Even if you do find a person willing to jump start your car being unsure of whether or not you have a set of jumper cables or knowingly not having one can further add to this already stressful situation. Aside from asking around for a jump from a relative or stranger current solutions exist so that the consumer can independently jump start their own car, but these solutions are not without their own flaws.

On the market existing portable power supplies that can provide a DC voltage to jump start the battery in cars. These portables power supplies are considered portable in the very loose sense to many of us. While they are moveable they can still be considered very heavy and cumbersome for people who aren't considerably strong. These portable power supplies can be extremely heavy with a weight in excess to the car battery they are charging. So while considered portable these solutions aren't necessarily convenient. Many of these portable power supplies are also essentially one time use and cannot be recharged. Also, when connected to a car battery an electric spark may be produced and the idea or anticipation of this electric spark may cause fear and trepidation for one's own safety to even perform the task to one who is not entirely comfortable with this automotive process. It can be surmised that these portable power supplies are not ideally suited for an emergency type situation but more or less to provide a power source more directed towards a user that is extremely familiar with cars due to extraneous features present (air compressor, DC power source, built in work light, battery status indicators, AC/DC adaptors). When in an emergency type situation when one is on the side of the road alone all you really need in a jump start. Not to mention the one disadvantage that is always relevant to us all is that these portable power supplies are relatively expensive and can have a cost easily in excess of over one hundred dollars. While being useful this product's price point and excessive features make it not entirely useful to a person who wants the peace of mind to keep a device in their car at all times for the time when an emergency situation arises.

The solution of jumper cables is probably one of the most common among all types of users. Jumper cables are relatively portable, inexpensive and have a single purpose not hindered by a complicated design, yet the jumper cable has one large disadvantage compared to the previous solution; they require you to connect to another car or battery. So even though you may have a pair of jumper cables you still require the assistance of another car. If a user is alone in a secluded area the anxiousness of waiting for this person to arrive can make minutes seem like hours and add to the already stressful situation. This extra stress on the person waiting is in addition to the possible inconvenience created for the person who is coming to assist you. Alternatively, the user could ask a stranger if they would be kind enough to provide their car for a jump start, but for some people this can create an inconvenient as well as awkward situation. Another disadvantage with jumper cables is that they require that the operator possess a fair amount of technical knowledge of their operation. Various dangerous situations can present themselves to a user who is unfamiliar with the operation of jumper cables such as overcharging which can produce flammable hydrogen gas inside the battery, a chance to accidentally short the good battery, or a spark can form if the cables are connected incorrectly which can cause the battery to explode. All these factors can create trepidation to even perform this task.

The most obvious solution probably is to keep an extra vehicle battery and just replace it when necessary. Aside from the obvious cost associated with keeping an extra battery in the trunk of your car at all times can be inconvenient. When the situation arises that a dead battery must be replaced having the necessary tools in addition to the weight of the extra battery may be more than some people are able to handle and this is a significant disadvantage in this most obvious of solutions.

### SUMMARY OF THE PRESENT INVENTION

A main object of the present invention is to provide a portable power supply with the means of electrically connecting to a vehicle battery to provide a DC voltage with the intention of jump starting a vehicle.

An additional object of the present invention is to provide a means to detachably connect and adapt a conventional battery pack from a conventional power tool to provide the DC voltage with the intention of jump starting a vehicle.

An additional object of the present invention is to provide an ultra portable and compact means of electrically connecting a power supply to a vehicle battery to provide a DC voltage with the intention of jump starting a vehicle.

An additional object of the present invention is to provide an inexpensive means to electrically connect a power supply to a vehicle battery to provide a DC voltage with the intention of jump starting a vehicle.

An additional object of the present invention is to provide a simple means to electrically connect a power supply to a vehicle to provide a DC voltage with the intention of jump starting a vehicle where the present invention is not complicated by extraneous features to complete the main objective.

An additional object of the present invention is to provide a safe means, in the form of an on/off switch, to electrically connect a power supply to a battery to provide a DC voltage with the intention of jump starting a vehicle where the production of a spark when terminal ends are connect to a battery is inhibited to provide a peace of mind for the operator if they are not familiar with typical battery jump start operation.

Accordingly, to accomplish the above objects, the present invention provides a pocket jumper, comprising:

a battery pack that is able to output a DC voltage adapted from a conventional battery pack for use with a conventional power tool wherein the battery pack is able to be recharged and maintain a minimum predetermined voltage with output terminals corresponding to positive and negative polarities and has a means to securely detachably connect to a locking mechanism;

a battery adaptor that provides a means to detachably connect and adapt to a conventional battery pack for use with a conventional power tool, wherein the battery pack is held secure in place by a locking mechanism and the battery adaptor contains terminals within the housing that allow for connection to the corresponding polarity terminals of the battery pack and are able to output the corresponding polarity to the terminal leads extending from the housing;

a pair of terminal leads in the form of insulated wires with a pair of conductive ends wherein a positive and negative polarity are distinct and are separated a predetermined width wherein the terminal leads have enough distance between them to allow for the simultaneous connection between the corresponding negative and positive polarity terminals on the inactive vehicle battery; additionally the insulated wires protect the user from an electric shock by inhibited a conductance of electricity; and

a clamping mechanism constructed of a conductive material that is constructed from a pair of rigid elements that contain a pinching element front and a handle element on the rear pivotally attached, wherein a resilient element is housed between the pair of rigid elements so that in the equilibrium state the pinching elements are pressed towards each other and the handle elements are spread apart, wherein when an operator grips the handles and squeezes the handles toward each other overcoming the force generated by the resilient element the pinching elements widen in a predetermined relation in comparison to the narrowing of the handles together; additionally the handles are covered with an insulating material preventing an electrical conductance to the operator when the operator completes the previously stated task.

In accordance with another aspect of the invention, the present invention comprises a device for converting a battery pack of a power tool into a power assembly with an intention of jump starting a vehicle, wherein the battery adaptor comprises a battery adaptor for detachably coupling with the battery pack, and a detachable connector extended from the battery adaptor for detachably connecting to a vehicle battery vehicle so as to electrically connect the battery pack with the vehicle battery with an intention of jump starting the vehicle. Therefore, the user is able to use any battery pack of the existing power tool to jump start the vehicle.

Still further objects and advantages will become apparent from a consideration of the ensuing descriptions and drawings.

These and other objectives, features, and advantages of the present invention will become apparent from the following detailed descriptions, the accompanying drawings, and the appended claims.

### BRIEF DESCRIPTION OF THE DRAWINGS

FIG. 1 is an exploded perspective view of the Pocket Jumper in preferred embodiment of the present invention.

FIG. 2A is a top view of the of the battery pack of the Pocket Jumper in the preferred embodiment of the present invention.

FIG. 2B is a top view of the of the battery adaptor of the Pocket Jumper in the preferred embodiment of the present invention.

FIG. 3 is a perspective view of the battery adaptor of the Pocket Jumper in the preferred embodiment of the present invention.

FIG. 4 is a view of the clamping mechanisms with a provided safety cover for the pinching elements of the preferred embodiment of the present invention.

FIG. 5 is a perspective view of the Pocket Jumper in an additional embodiment of the present invention depicting a USB adaptor.

FIG. 6 is a perspective view of the pocket jumper according to another embodiment of the present invention.

### DETAILED DESCRIPTION OF THE PREFERRED EMBODIMENT

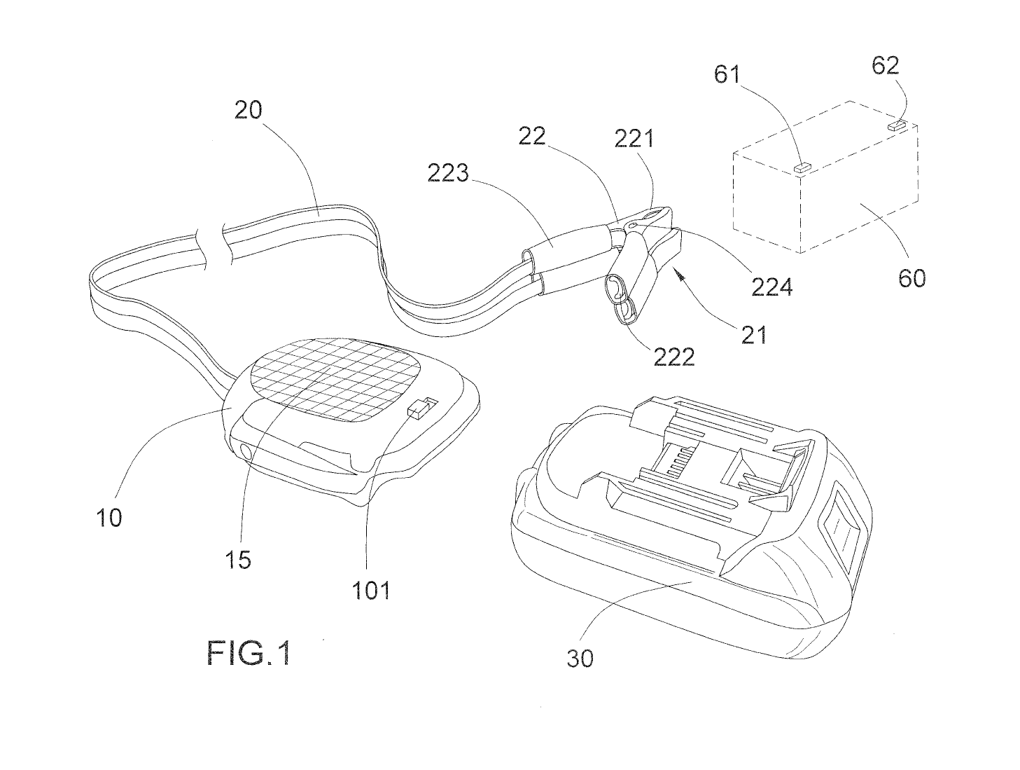

FIG. 1 is a perspective view of the Pocket Jumper in preferred embodiment of the present invention. In this preferred embodiment of the present invention the Pocket Jumper comprises a power assembly and a detachable connector. The power assembly is ultra compact, lightweight, and able to adapt to a conventional rechargeable battery designed for use with power tools. The power assembly has a pocket size that the user is able to carry the power assembly conveniently. The power assembly comprises a battery adaptor 10 that a pair of insulated wires 20 of the detachable connector are integrally extended therefrom, insulated to prevent a user from getting electrically shocked, which correspond to a positive and negative polarity each of which is connected to the detachable connector which are clamping mechanisms 21 thereof. The insulated wires 20 of the detachable connector are affixed to each other and separate at a predetermined distance that allows for the clamping mechanisms 21 of the detachable connector to separate a predetermined width so that a simultaneous connection between the corresponding positive and negative polarity terminals, 61 and 62 respectively, on the depleted energy source 60 and the clamping mechanisms 21, such as clamping clips, can be made. These clamping mechanisms 21 are constructed from a conductive material so that when a circuit is created between the battery pack 30 and the depleted energy source 60, the energy from the battery pack 30 can be conducted to this depleted energy source 60. Accordingly, the depleted energy source 60 can be the vehicle battery.

The battery adaptor 10 provides means to detachably connect and adapt a battery pack 30 from a conventional power tool to provide the DC voltage to a depleted energy source 60 with the intention of jump starting a vehicle. When the battery adaptor 10 is mounted and connected to the battery pack 30 of the power assembly, the battery adaptor 10 allows for a circuit to be created when the clamping mechanisms 21 are clamped to the corresponding polarity terminals of a depleted energy source 60 such as the vehicle battery so that the device powered by the depleted energy source 60 may take advantage of the completed electrical circuit provided by the Pocket Jumper. The completed circuit allows for vehicles to utilize the stored energy in the Pocket Jumper and effectively allows for a “jump start” of a vehicle. It is worth mentioning that the battery adaptor 10 fully encloses the mounted battery pack 30 and no exposed areas where the operator can be electrically shocked are present increasing the overall safety of the present invention. In other words, the battery adaptor 10 can be from a device for converting the battery pack 30 of the conventional power tool into the power assembly with an intention of jump starting the vehicle.

The clamping mechanism 21 of the detachable connector that provide a means of conductance between the battery pack 30, battery adaptor 10, insulating wires 20 and the depleted energy source 60 are constructed out of a conductive material and are comprised of a pair of rigid elements 22 that contain a pinching element 221 on the front and a handle element 222 on the rear which are pivotally attached. When the rigid elements 22 are pivotally attached to each other a resilient element 224 is placed between the rigid elements 22 so that in the equilibrium state the pinching elements 221 are pressed towards each other and the handle elements 222 are spread apart. When the handles 222 are squeezed together and the force generated by the resilient element 224 is overcame the pinching elements 221 are widened. It is worth mentioning that the handle elements 222 are covered with an insulating material 223 that will prevent an electrical conductance to the operator when the operator handles the clamping mechanisms 21 when they are connected to form an electrical circuit.

To operate the Pocket Jumper in this preferred embodiment of the present invention the user can selected from two different methods, utilizing the on/off switch 101 to prevent the production of the electric spark or creating the connection with the clamping mechanisms 21 and then connecting the battery pack 30 into the battery adaptor 10. In either method the first step of the process is to first affix the clamping mechanisms 21 onto the corresponding positive and negative polarity terminals 61 and 62 respectively, of the depleted energy source 60. The clamping mechanisms 21 have insulating covers 223 on the handle elements that will correspond to the polarity terminals on the depleted energy source 60 the clamping mechanisms 21 should be affixed onto. Once the clamping mechanisms 21 have been affixed to the proper corresponding terminals this is where the two methods of operation can differ.

In particular, the method of jump-starting a vehicle having a vehicle battery by the pocket jumper comprises the following steps.

(1) Switch the on/off switch 101 of the power assembly at the “off” position. At the same time, the battery pack 30 is preferably detached from the battery adaptor 10 before the detachable connector is connected to the depleted energy source 60 for ensuring no electrical connection being formed between the battery pack 30 and the depleted energy source 60.

(2) Detachably connect the detachable connector to the depleted energy source 60 while no electrical connection is formed between the battery pack 30 of the power assembly and the depleted energy source 60.

(3) Switch the on/off switch 101 at the “on” position to electrically connect the battery pack 30 with the depleted energy source 60 with an intention of jump starting the vehicle. Before the on/off switch 101 is switched to the “on” position, the battery pack 30 is coupled to the battery adaptor 10. Therefore, once the on/off switch 101 is switched to the “on” position, the battery pack 30 is electrically connected with the depleted energy source 60. In other words, the battery pack 30 is coupled to the battery adaptor 10 after the detachable connector is connected to the depleted energy source 60.

If the battery pack 30 is already mounted on the battery adaptor 10 change the on/off switch 101 from the off position to the on (it is worth mentioning that the on/off switch 101 should be initially in the off position before this process is started). Once the on/off switch 101 is moved to the on position a circuit is created with the battery pack 30 and the depleted energy source 60 through the present invention. The device attached to this depleted energy source 60 can now be jump started by utilizing the connection with the battery pack 30. Since the clamping mechanisms 21 are mounted onto the positive and negative polarity terminals 61 and 62 respectively, of the depleted energy source 60 before a circuit is created to allow the flow of electrons no spark is formed, thereby creating a safer method to jump start a vehicle. Once the vehicle is jump started the on/off switch 101 on the battery adaptor 10 should be now set to the off position so that electrons no longer flow through the Pocket Jumper and the clamping mechanisms 21 can be detached from the corresponding polarity terminals of the depleted energy source 60 without the risk of electric shock.

If the battery pack 30 is not mounted in the battery adaptor 10 before the clamping mechanisms 21 are affixed to the corresponding polarity terminals of the depleted energy source 60 the operator may insert a battery pack 30 into the battery adaptor 10 at that point so that no electrical spark will be formed. It is worth mentioning that to further increase the safety of the operation the on/off switch 101 of the battery adaptor 10 should be in an off position before inserting a battery pack 30, this will prevent the danger of an electric shock. Once the on/off switch 101 is moved to the on position a circuit is created with the battery pack 30 and the depleted energy source 60 through the present invention. The device attached to this depleted energy source 60 can now be jump started by utilizing the connection with the battery pack 30. Since the clamping mechanisms 21 are mounted onto the positive and negative polarity terminals 61 and 62 respectively, of the depleted energy source 60 before a circuit is created to allow the flow of electrons no spark is formed, thereby creating a safer method to jump start a vehicle. Once the vehicle is jump started the on/off switch 101 on the battery adaptor 10 should be now set to the off position so that electrons no longer flow through the Pocket Jumper and the clamping mechanisms 21 can be detached from the corresponding polarity terminals of the depleted energy source 60 without the risk of electric shock.

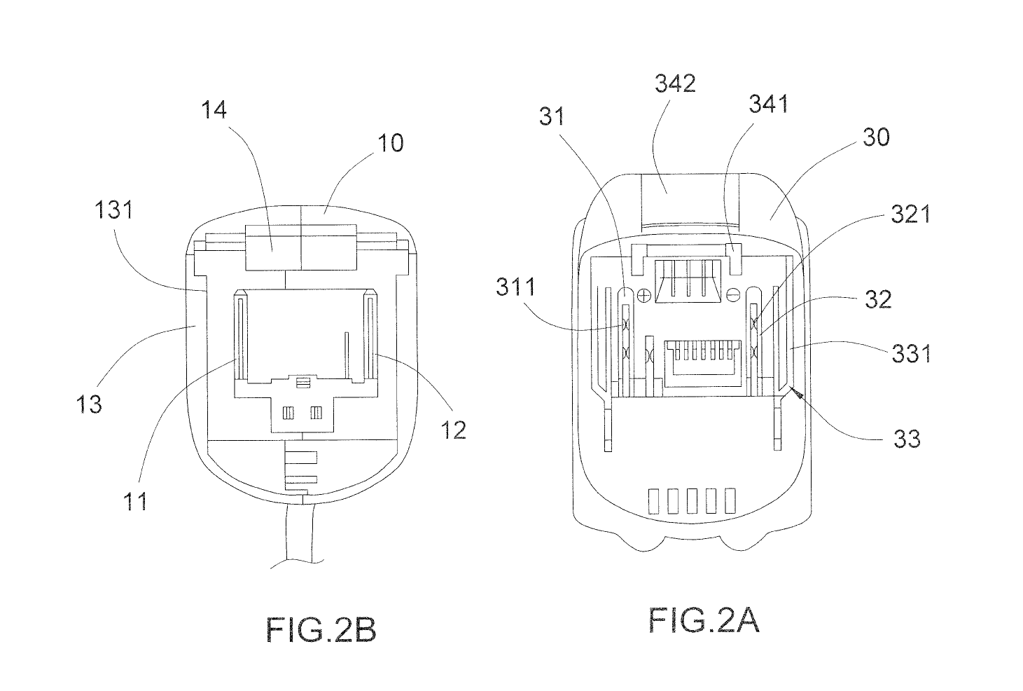

FIG. 2a is a top view of the battery pack 30 of the Pocket Jumper in the preferred embodiment of the present invention. The battery pack 30 of any conventional power tool may be adapted to be mounted to the present invention, and should not be limited by the preferred embodiment of the present invention. Preferably, the battery pack 30 comprises a rechargeable battery which is one of nickel cadmium (NiCd), nickel metal hydride (NiMH), and lithium ion (Li-ion). In this preferred embodiment the battery pack 30 is comprised of a positive polarity terminal connecting port 31 and a negative polarity terminal connecting port 32. Within these positive or negative polarity terminal connecting ports 31 and 32 respectively, are conductive connector elements 311 and 321 which correspond to the positive and negative terminal connecting ports respectively, that are able to interface with conductive elements located similarly on the battery adaptor 10 when the battery adaptor 10 is connected to the battery pack 30. The conductive connector elements in this preferred embodiment of the present invention are embodied as conductive resilient elements so that a constant pressure is applied when the positive and negative polarity connection terminals 31 and 32 respectively, of the battery adaptor 10 are inserted to ensure constant electrical conductance. These conductive connector elements allow for the circuit to be created that allows the flow of electrons allowing the present invention to energize a depleted energy source such a vehicle battery. To ensure that the conductive connectors are aligned properly, battery pack has battery guide rails for locking mechanism 33 are located on the longitudinal sides of the battery pack 30. This battery guide rail for locking mechanism 33 allows the battery adaptor 10 to slide properly in place to the battery pack 30 and ensure that the conductive connectors 311 and 321 are properly aligned. The battery guide rail for locking mechanism 33 contains a guide edge 331 and a cavity for battery guide rail 332. The battery adaptor 10 contains similar elements so that when these elements are coupled by orientating the guide edge 331 of the battery pack 30 with the cavity for the battery adaptor guide rail and orientating the guide edge of the battery adaptor with the cavity for the battery pack guide rail and are slide into each other the elements come into a surface contact allowing for a flush fitting between the two elements.

The top perspective view of the battery pack of the Pocket Jumper in this preferred embodiment of the present invention also depicts a locking mechanism 34 so that when the battery adaptor 10 is mounted on the battery pack 30 there is no risk of the two becoming decoupled. In this preferred embodiment of the present invention an angled rigid element 341 which is pressed upward in by a resilient element in the base of the battery pack 30. This angled rigid element 341 is connected to the lock release 342 so that when the lock release 342 is pressed downward the angled rigid element 341 moves an identical downward distance that the lock release 342 has traveled.

FIG. 2b is a top view of the battery adaptor of the Pocket Jumper in the preferred embodiment of the present invention. From this perspective of the battery adaptor 10 the positive and negative connecting terminals 11 and 12, respectively, can be seen along with the adaptor guide rail for locking mechanism 131. When the battery adaptor 10 and the battery pack 30 are mounted as previously described in FIG. 2a the adaptor guide rails for locking mechanism 13 interface with the battery guide rail for locking mechanism 33 wherein each of the corresponding guide rails are comprised of a cavity 132 and guide edge 131 wherein the guide edge 331 of the battery pack 30 is designed to fit into the cavity 132 of the battery adaptor 10 and the guide edge 131 of the battery adaptor is designed to fit into the cavity of the battery pack 332. This allows each of the guide rails of both the battery pack 30 and the battery adaptor 10 to allow the battery pack 30 and the battery adaptor 10 to slide and mount with each other and ensuring that the positive and negative polarity connecting terminals 11 and 12, respectively, are positioned properly to create a circuit between the battery pack 30 and the depleted energy source 60. The adaptor guide rail for locking mechanism 13 also ensures that the angled slot 14 for locking mechanism 34 aligns properly with the angled rigid element 341 located on the topside of the battery pack 30.

As shown in FIG. 1, the battery adaptor 10 further comprises a solar energy collector 15 provided at a top side, wherein the battery pack 30 is detachably coupled at the bottom side of the battery adapter 10. When the battery pack 30 is coupled to the battery adapter 10, the battery pack 30 can be charged by means of solar energy via the solar energy collector 15.

In this preferred embodiment of the present invention the locking mechanism 34 for the Pocket Jumper is embodied as a previously described angled rigid element 341 that is kept upright by a resilient element housed within the battery pack 30 and an angled slot 14 for locking mechanism 34 located on the underside of the battery adaptor 10. When the battery pack 30 and the battery adaptor 10 are slide into each other to be mounted the edge of the battery adaptor 10 will come into contact with the angled rigid element 341 when it is slide into the final position. When the rear edge of the battery adaptor 10 comes into contact with this angled surface and moves further towards the final position this will cause the angled rigid element 341 to move downward due to the fact that since it is angled the battery adaptor edge attempts to move up the incline but since it is locked into a set vertical orientation it overcomes the resilient element that holds up the angled rigid element 341 and thus forces the angled rigid element 341 downward as the edge of the battery pack moves towards the edge until the angled rigid element 341 is completely under the battery pack edge. When the battery adaptor 10 reaches the final position the angled slot for locking mechanism 14 is orientated over the angled rigid element 341 allowing the angled rigid element 341 to be pushed upward by the resilient element fitting flush in the angled slot for the locking mechanism 14 thereby locking the battery pack 30 and the battery adaptor 10 together. To release the locking mechanism 34 and allowing the battery pack 30 and the battery adaptor 10 to decouple from this locked state the user pushes the lock release 342 which is integrated with the angled rigid element 341. When the lock release 342 is pressed and the force generated by the resilient element is overcame this allows the angled rigid element 341 to be lowered from the flush fitting within the underside of the battery adaptor 10 allowing the battery adaptor 10 and the battery pack 30 to slide away from each other guided by the guide rails on each of these elements.

When the battery pack 30 and the battery adaptor 10 are coupled together and the conductive elements of each of these elements are communicating with each other the transforming circuitry allows this energy to be converted into the desired state for the task at hand and transferred through the insulated wires and the clamping mechanism 21.

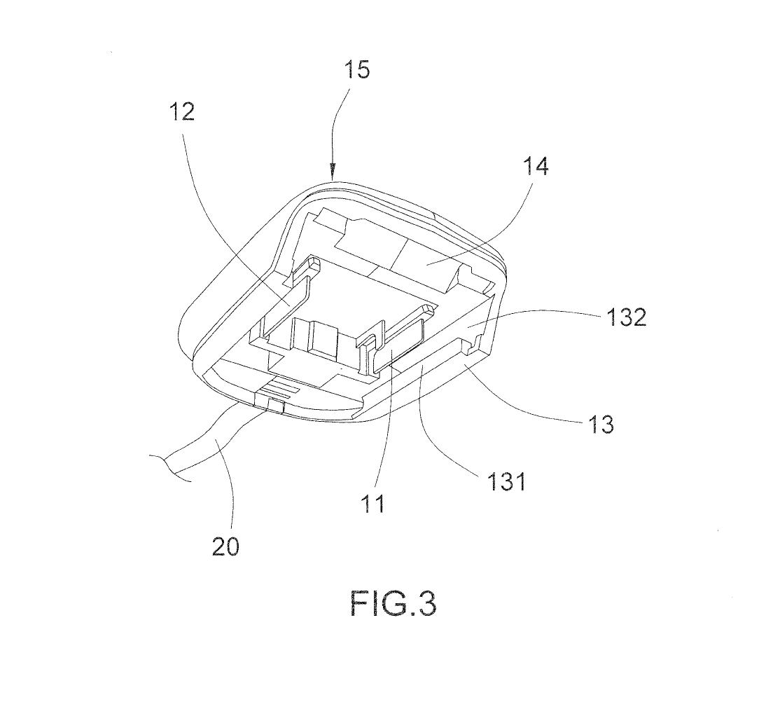

FIG. 3 is a perspective view of the battery adaptor of the Pocket Jumper in the preferred embodiment of the present invention. In this view of the preferred embodiment of the present invention the cavities 132 of the battery adaptor guide rail for locking mechanism 13 can be better seen. This guide rail structure is mirrored on the other edge of this battery adaptor 10. It is worth mentioning that the battery pack 30 has s corresponding similar structure so that when the guide rails from each of these elements are coupled they create a flushed structure with minimal extraneous movement.

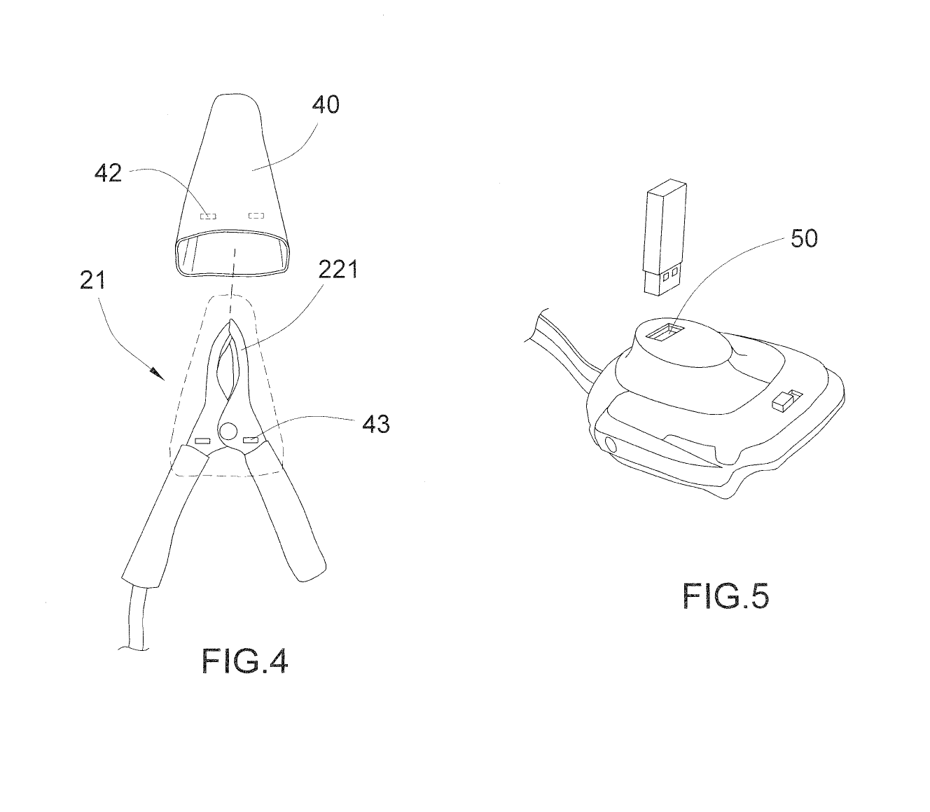

FIG. 4 is a view of the clamping mechanisms 21 with a provided safety cover 40 for the pinching elements 221 of the preferred embodiment of the present invention. With the safety covers 40 over the pinching elements 221 of the clamping mechanism 21, accidental electrical shock is lessened in the case there is accidental contact when the clamping mechanism 21 are being affixed to the depleted energy source 60 or if there happens to be a latent electrical charge left on the conductive material. In this present embodiment of the present invention the safety covers 40 for the pinching elements 221 are constructed from an insulating, non conductive material that when placed over the pinching elements 221 cover all the conductive material of the clamping mechanism 21 so that there is no risk of electrical shock to the operator. Additionally, affixed to the inner cavity of the safety cover 40 is a loop portion 42 of a hooked-loop fastener wherein the corresponding hooked portion 43 of this hooked-loop fastener is located on the clamping mechanism 21 wherein when the safety cover 40 is on the clamping mechanism 21 the hooked-loop fasteners are able to come into contact and adhere to each other so that the safety cover does not become accidentally detached from the clamping mechanism 21 or become lost so that the clamping mechanism 21 is without a safety cover.

FIG. 5 is a perspective view of the Pocket Jumper in an additional embodiment of the present invention depicting a charging port for electrically connecting and charging an electronic device by the battery pack 30, wherein the charging port is embodied as a USB adaptor 50. In this additional embodiment of the present invention a USB adaptor 50 is included because in addition to requiring a jump start for our car at times it might be necessary to contact someone with a cellular phone. The USB adaptor 50 provides additional assurance that the operator is able to make an emergency phone call even if the cellular phone has a depleted battery 60. The USB adaptor 50 allows for a connection to a cellular phone with the means to charge the cellular phone or provide a DC power so that the cellular phone may be used.

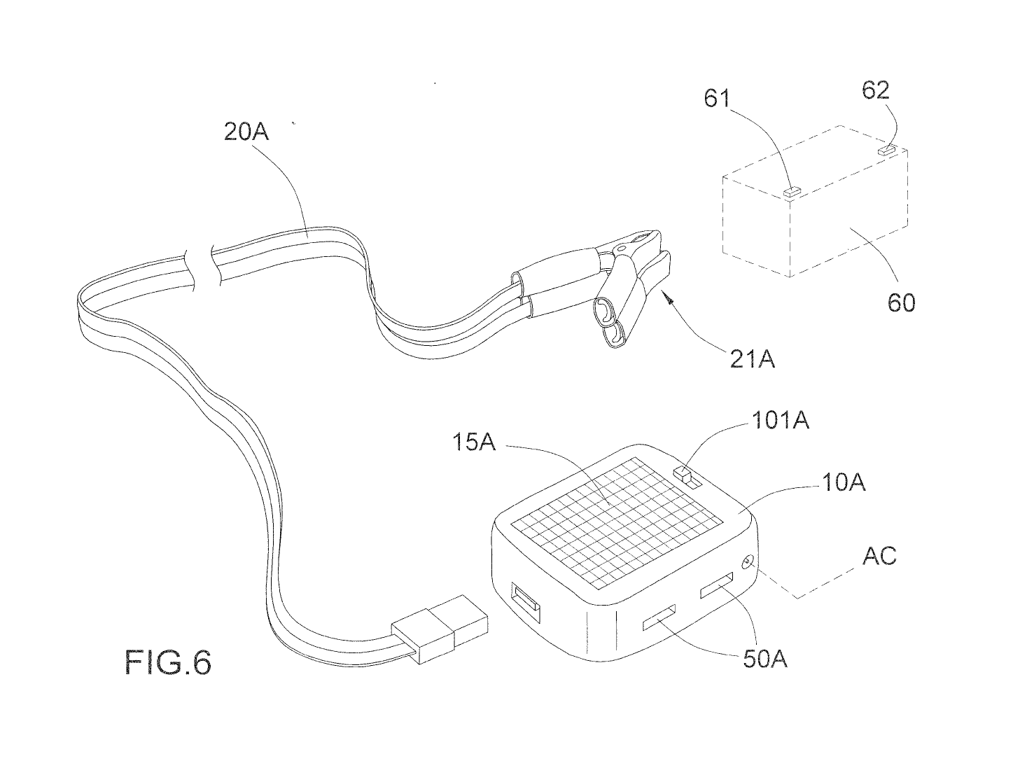

FIG. 6 illustrates an alternative mode of the pocket jumper, wherein the battery adaptor and the battery pack are integrated to form a power assembly 10A, wherein the detachable connector is detachably coupled with the power assembly 10A. In particular, the insulated wires 20A are detachably coupled with the power assembly 10A via a plug-and-socket structure, wherein the clamping mechanisms 21A are provided the insulated wires 20A respectively.

Accordingly, the power assembly 10A can be charged by a conventional AC power or by the solar energy collector 15A provided at the top side of the power assembly 10A. The charging port 50A is also provided at the power assembly 10A for electrically connecting and charging the electronic device.

Since the battery adaptor and the battery pack are integrated to form the power assembly 10A, the battery pack cannot be detached from the battery adaptor. Therefore, in the above step (1), the on/off switch 101A of the power assembly 10A should be switched at the “off” position as well. At the same time, the detachable connector is preferably detached from the power assembly 10A before the detachable connector is connected to the depleted energy source 60 for ensuring no electrical connection being formed between the battery pack 30 and the depleted energy source 60.

Therefore, in the step (2), the user is able to detachably connect the detachable connector to the depleted energy source 60 by detachably connecting the clamping mechanisms 21A at the polarity terminals 61 and 62 of the depleted energy source 60 respectively, such that no electrical connection is formed between the power assembly 10A and the depleted energy source 60.

Once the detachable connector is connected to the depleted energy source 60, the detachably connector is then connected to the power assembly 10A while the on/off switch 101 of the power assembly is remained at the “off” position.

In the step (3), the user is able to switch the on/off switch 101 at the “on” position to electrically connect the power assembly 10A with the depleted energy source 60 with an intention of jump starting the vehicle.

It should be appreciated that the detachable connector can be detachably extended from the battery adapter 10 as in FIG. 1. The detachably connecting feature of the detachable connector applied to the detachably connecting feature of the battery pack 30 and the battery adaptor 10. For providing double-safety feature, the user is able to always switch the on/off switch 101 of the power assembly at the “off” position in the step (1). At the same time, the detachable connector is preferably detached from the battery adapter 10 and the battery pack 30 is preferably detached from the battery adaptor 10 before the detachable connector is connected to the depleted energy source 60. After the detachable connector is detachably connected to the depleted energy source 60, the user is able to detachably connect the detachably connector to the battery adapter 10 and then detachably connect the battery pack 30 to the battery adaptor 10. The user will always switch the on/off switch 101 at the “on” position, as the final step, to electrically connect the battery pack 30 with the depleted energy source 60.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A pocket jumper for jump-starting a vehicle having a vehicle battery, comprising:
a power assembly which comprises a rechargeable battery pack and an on/off switch being switched between an “off” position and an “on” position; and
a detachable connector extended from said power assembly for detachably connecting to said vehicle battery, wherein when said on/off switch is switched at said “off” position, said detachable connector is connected to said vehicle battery that no electrical connection is formed between said battery pack and said vehicle battery, wherein when said on/off switch is switched at said “on” position, said detachable connector is connected to said vehicle battery to electrically connect said battery pack with said vehicle battery with an intention of jump starting the vehicle.

2. The pocket jumper, as recited in claim 1, wherein said power assembly further comprises a battery adaptor detachably coupled with said battery pack, wherein said detachable connector is extended from said battery adaptor in such a manner that before said battery pack is coupled to said battery adaptor, said detachable connector is arranged for connecting to said vehicle battery for ensuring no electrical connection being formed between said battery pack and said vehicle battery.

3. The pocket jumper, as recited in claim 1, wherein said battery pack comprises a rechargeable battery selected from the group consisting of nickel cadmium (NiCd), nickel metal hydride (NiMH), and lithium ion (Li-ion).

4. The pocket jumper, as recited in claim 2, wherein said battery pack comprises a rechargeable battery selected from the group consisting of nickel cadmium (NiCd), nickel metal hydride (NiMH), and lithium ion (Li-ion).

5. The pocket jumper, as recited in claim 1, further comprising a solar energy collector provided at said power assembly to charge said battery pack by means of solar energy.

6. The pocket jumper, as recited in claim 4, further comprising a solar energy collector provided at said power assembly to charge said battery pack by means of solar energy.

7. The pocket jumper, as recited in claim 1, wherein said power assembly further comprises a charging port for electrically connecting and charging an electronic device by said battery pack.

8. The pocket jumper, as recited in claim 4, wherein said power assembly further comprises a charging port for electrically connecting and charging an electronic device by said battery pack.

9. The pocket jumper, as recited in claim 1, wherein said detachable connector is detachably coupled with said power assembly.

10. The pocket jumper, as recited in claim 4, wherein said detachable connector is detachably coupled with said power assembly.

11. A method of jump-starting a vehicle having a vehicle battery by a pocket jumper which comprises a power assembly and a detachable connector, wherein the method comprises the steps of:
(a) switching an on/off switch of said power assembly at an “off” position;
(b) detachably connecting said detachable connector to said vehicle battery while no electrical connection is formed between a rechargeable battery pack of said power assembly and said vehicle battery; and
(c) switching said on/off switch at an “on” position to electrically connect said battery pack with said vehicle battery with an intention of jump starting the vehicle.

12. The method, as recited in claim 11, wherein the step (a) further comprises a step of detaching said battery pack from a battery adaptor before said detachable connector is connected to said vehicle battery for ensuring no electrical connection being formed between said battery pack and said vehicle battery.

13. The method, as recited in claim 12, wherein the step (c) further comprises a step of coupling said battery pack to said battery adaptor after said detachable connector is connected to said vehicle battery.

14. The method, as recited in claim 13, wherein the step (b) further comprises a step of detachably coupling said detachable connector with said power assembly after said detachable connector is connected to said vehicle battery.

15. The method, as recited in claim 11, further comprising a step of charging said battery pack by means of solar energy.

16. The method, as recited in claim 11, further comprising a step of providing a charging port for electrically connecting and charging an electronic device by said battery pack.

17. A device for converting a battery pack of a power tool into a power assembly with an intention of jump starting a vehicle, wherein the battery adaptor comprises:
a battery adaptor for detachably coupling with said battery pack; and
a detachable connector extended from said battery adaptor for detachably connecting to a vehicle battery vehicle so as to electrically connect said battery pack with said vehicle battery with an intention of jump starting the vehicle.

18. The device, as recited in claim 17, wherein said battery adaptor further comprises an on/off switch being switched between an “off” position for ensuring no electrical connection being formed between said battery pack and said vehicle battery, and an “on” position for electrically connecting said battery pack with said vehicle battery.

19. The device, as recited in claim 18, further comprising a solar energy collector provided at said battery adaptor for charging said battery pack by means of solar energy.

20. The device, as recited in claim 18, wherein said battery adaptor further comprises a charging port for electrically connecting and charging an electronic device by said battery pack.

21. The device, as recited in claim 18, wherein said detachable connector is detachably coupled with said battery adaptor.
